(19) United States
(12) Patent Application Publication
(10) Pub. No.: US 2007/0092743 A1
(43) Pub. Date: Apr. 26, 2007

(54) Liquid crystal display

(75) Inventors: Yong-Kuk Yun, Suwon-si (KR); Soon-Joon Rho, Suwon-si (KR); Yong-Hwan Shin, Yongin-si (KR)

Correspondence Address: F. CHAU & ASSOCIATES, LLC, 130 WOODBURY ROAD, WOODBURY, NY, 11797, US

(73) Assignee: Samsung Electronics Co., Ltd., Suwon-si (KR)

(21) Appl. No.: 11/527,144

(22) Filed: Sep. 26, 2006

(30) Foreign Application Priority Data
Sep. 28, 2005 (KR) 10-2005-0090381

(51) Int. Cl. B32B 27/34

(52) U.S. Cl. 428/474.4

(57) ABSTRACT

A liquid crystal display includes a first panel and a second panel, an alignment layer formed on at least one of the first panel and the second panel, and a liquid crystal layer interposed between the first display panel and the second display panel and comprising liquid crystal molecules. The alignment layer includes a polymer comprising a polyamic acid having having a plurality of amic acid groups and a polyimide having a plurality of imide groups. The polymer has an imidization ratio of at least about 85%.

### CROSS-REFERENCE TO RELATED APPLICATION

This application claims priority to and the benefit of Korean Patent Application No. 10-2005-0090381 filed in the Korean Intellectual Property Office on Sep. 28, 2005, the disclosure of which is hereby incorporated by reference herein in its entirety.

### BACKGROUND OF THE INVENTION

(a) Techical Field

The present disclosure relates to a liquid crystal display.

(b) Description of the Related Art

Liquid crystal displays (LCD) are a widely used type of flat panel display. A liquid crystal display typically includes two display panels provided with field-generating electrodes such as pixel electrodes and common electrodes, and has a liquid crystal (LC) layer interposed therebetween. In the liquid crystal display, a voltage is applied to the field generating electrodes so as to generate an electric field, and then the alignment of liquid crystal molecules of the liquid crystal layer is determined by the electric field. Accordingly, the transmittance of light passing through the liquid crystal layer is controlled.

Furthermore with the liquid crystal display, the liquid crystals rotate via an electric field generated between a pixel electrode and a common electrode to change the transmittance of light, thereby resulting in images being displayed by the liquid crystal display in response to the change in light transmittance. The electric field generated between the pixel electrode and the common electrode is controlled by the pixel electrode, and the voltage of the pixel electrode is controlled by a switching element such as a thin film transistor (TFT). The thin film transistor transmits or intercepts image signals that are transmitted along data lines, to or from the pixel electrode, by scanning signals transmitted along gate electrode lines.

When a voltage is not applied to the pixel electrode and the common electrode, the liquid crystal molecules in the liquid crystal layer are arranged in a predetermined direction by an alignment layer that is formed on a thin film transistor array panel and a surface of a common electrode panel. On the other hand, when a voltage is applied to pixel electrode and the common electrode, the liquid crystal molecules rotate according to the electric field direction.

Moreover, as the liquid crystal display is a non-emissive element, additional light should be provided from the inside or outside of the liquid crystal display. Therefore, a backlight unit may be provided on a rear surface of the thin film transistor array panel.

However, when the liquid crystal display is driven for a long period of time, the liquid crystal display may be deteriorated due to light from the backlight unit. The above-mentioned deterioration of the liquid crystal display may lead to a decrease in the voltage holding ratio (VHR), which is defined as a ratio of the voltage difference between the pixel electrode and a common electrode after the thin film transistor turns off relative to the initial voltage difference. In addition, when the liquid crystal display is driven for a long period of time, this may lead to display irregularities such as horizontal lines or vertical lines visibly occurring in the display region, which thereby may shorten the life span of a large screen liquid crystal display and deteriorate the display characteristics as well.

Thus, there is a need for an LCD and method which prevents a decrease in the voltage holding ratio and which reduces display irregularities.

### SUMMARY OF THE INVENTION

In accordance with an exemplary embodiment of the present invention, a liquid crystal display is provided. The liquid crystal display includes a first panel and a second panel that face each other, an alignment layer formed on at least one of the first panel and the second panel, and liquid crystal interposed between the first panel and the second panel and comprising liquid crystal molecules. The alignment layer includes a polymer including a polyamic acid having a plurality of amic acid groups and a polyimide having a plurality of imide groups. Moreover, the polymer has an imidization ratio of at least 85%.

Furthermore, the polyamic acid having a plurality of amic acid groups is represented by Formula (I): and

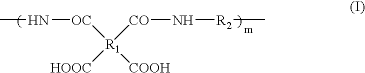

the polyimide having a plurality of imide groups is represented by Formula (II):

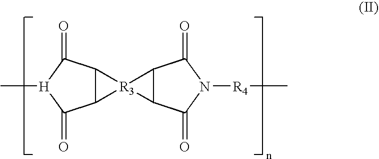

wherein R₁, R₂, R₃, and R₄, which may be same or different from each other, are each selected from an aliphatic group or an aromatic group; and m and n are each an integer.

The moieties 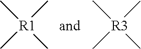
may be at least one selected from the following:

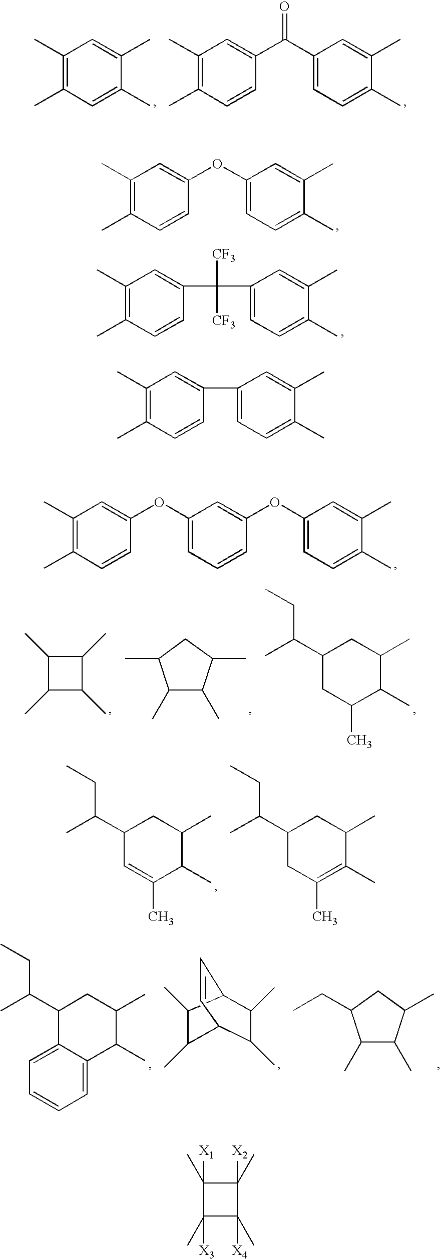

Further, the moieties —R2— and —R4— may include at least one selected from the following:

The polymer can be obtained by copolymerizing a tetracarboxylic dianhydride with a diamine compound.

The tetracarboxylic dianhydride may be selected from an aliphatic tetracarboxylic dianhydride and an aromatic tetracarboxylic dianhydride. The aliphatic tetracarboxylic dianhydride is at least one selected from the group consisting of 1,2,3,4-cyclobutane tetracarboxylic dianhydride, 1,2,3,4-cyclopentane tetracarboxylic dianhydride, 5-(2,5-dioxotetrahydrofuryl)-3-methylcyclohexane-1,2-dicarboxylic dianhydride, 5-(2,5-dioxotetrahydrofuryl)-3-methyl-3-cyclohexene-1,2-dicarboxylic dianhydride, 5-(2,5-dioxotetrahydrofuryl)-3-methyl-4-cyclohexene-1,2-dicarboxylic dianhydride, 4-(2,5 -dioxotetrahydrofuryl-3-yl)-tetraline-1,2-dicarboxylic dianhydride, bicyclooctene-2,3,5,6-tetracarboxylic dianhydride, 2,3,5-tricarboxylcyclopentylcarboxylic dianhydride, 1,2,3,4-tetramethyl-1,2,3,4-cyclobutane tetracarboxylic dianhydride, 1,2-dimethyl-1,2,3,4-cyclobutane tetracarboxylic dianhydride, 1-methyl-1,2,3,4-cyclobutane tetracarboxylic dianhydride, 1,2,3,4-tetrafluoro-1,2,3,4-cyclobutane tetracarboxylic dianhydride, 1,2-difluoro-1,2,3,4-cyclobutane tetracarboxylic dianhydride, 1-fluoro-1,2,3,4-cyclobutane tetracarboxylic dianhydride, 1,2-dimethyl-3,4-difluoro-1,2,3,4-cyclobutane tetracarboxylic dianhydride, 1-methyl-3-fluoro-1,2,3,4-cyclobutane tetracarboxylic dianhydride, and 1-methyl-4-fluoro-1,2,3,4-cyclobutane tetracarboxylic dianhydride, while the aromatic tetracarboxylic dianhydride is at least one selected from the group consisting of pyromellitic dianhydride, benzophenone tetracarboxylic dianhydride, oxydiphthalic dianhydride, biphthalic anhydride, and hexafluoroisopropylidene diphthalic dianhydride.

Further, the diamine compound can be represented by Formula (III):

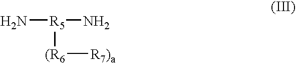

wherein R₅ is an aliphatic group or an aromatic group; R₆ is one selected from —O—, —COO—, —OCO—, —NHCO—, and —CONH—; R₇ is a group selected from a linear, branched, or cyclic alkyl group having 1 to 30 carbon atoms, an unsaturated hydrocarbon group having 7 to 40 carbon atoms, a saturated cyclic hydrocarbon group, and a mixture thereof; and a is an integer from 1 to 10.

The diamine compound may include at least one selected from the group consisting of p-phenylenediamine, m-phenylenediamine, 4,4-oxydianiline, 4,4-methylenedianiline, 2,2-bis(aminophenyl)hexafluoropropane, m-bis(aminophenoxy)diphenylsulfone, p-bis(aminophenoxy)diphenylsulfone, 1,4-bis(aminophenoxy)benzene, 1,3-bis(aminophenoxy)benzene, 2,2-bis[(aminophenoxy)phenyl]propane, and 2,2-bis[(aminophenoxy)phenyl]hexafluoropropane.

Further, the diamine monomer may contain a functional group that maintains the vertically aligning force of the liquid crystal molecules.

The tetracarboxylic dianhydride monomer and the diamine monomer may be copolymerized at a ratio of about 1:1.

The polymer may have a weight average molecular weight (Mw) of about 10,000 to about 250,000 g/mol.

The first panel may include a first substrate, gate lines formed on the first substrate, data lines crossing the gate lines, a thin film transistor connected to the gate lines and the data lines, and a pixel electrode connected to the thin film transistor.

The pixel electrode may have a cutout.

Furthermore, the liquid crystal molecules have negative dielectric anisotropy, and may be vertically aligned to the first panel and the second panel.

The liquid crystal display may further include a tilt direction determining member that determines the direction of tilting of the liquid crystal molecules in the liquid crystal layer.

The tilt direction determining member may have a cutout formed in at least one of the pixel electrode and the common electrode, or a protrusion formed on at least one of the pixel electrode and the common electrode.

In addition, in accordance with an exemplary embodiment of the present invention, a method for manufacturing a liquid crystal display is provided. The method includes forming a first signal line on the first substrate, a second signal line crossing the first signal line while being insulated, a thin film transistor connected to the first signal line and the second signal line, and a pixel electrode connected to the thin film transistor, forming a common electrode on a second substrate to face the pixel electrode, preparing a polymer which includes a polyamic acid having a plurality of amic groups and a polyimide having a plurality of imide groups, applying the polymer on at least one of the pixel electrode and the common electrode and curing the polyamic acid to form a copolymer having an imidization ratio of at least about 85%.

The curing of the polyamic acid may be carried out at a temperature of about 180 to about 250° C.

The curing of the polyamic acid may be also carried out for about 10 to about 20 minutes.

The preparing of the polyamic acid may include copolymerizing a tetracarboxylic dianhydride monomer and a diamine monomer, and dissolving the copolymerized compound in a solvent.

The tetracarboxylic dianhydride monomer may include at least one of an aliphatic tetracarboxylic dianhydride and an aromatic tetracarboxylic dianhydride. The aliphatic tetracarboxylic dianhydride may include at least one of 1,2,3,4-cyclobutane tetracarboxylic dianhydride, 1,2,3,4-cyclopentane tetracarboxylic dianhydride, 5-(2,5-dioxotetrahydrofuryl)-3-methylcyclohexane-1,2-dicarboxylic dianhydride, 5-(2,5-dioxotetrahydrofuryl)-3-methyl-3-cyclohexene-1,2-dicarboxylic dianhydride, 5-(2,5-dioxotetrahydrofuryl)-3-methyl-4-cyclohexene-1,2-dicarboxylic dianhydride, 4-(2,5-dioxotetrahydrofuryl-3-yl)-tetraline-1,2-dicarboxylic dianhydride, bicyclooctene-2,3,5,6-tetracarboxylic dianhydride, 2,3,5-tricarboxylcyclopentylcarboxylic dianhydride, 1,2,3,4-tetramethyl-1,2,3,4-cyclobutane tetracarboxylic dianhydride, 1,2-dimethyl-1,2,3,4-cyclobutane tetracarboxylic dianhydride, 1-methyl-1,2,3,4-cyclobutane tetracarboxylic dianhydride, 1,2,3,4-tetrafluoro-1,2,3,4-cyclobutane tetracarboxylic dianhydride, 1,2-difluoro-1,2,3,4-cyclobutane tetracarboxylic dianhydride, 1-fluoro-1,2,3,4-cyclobutane tetracarboxylic dianhydride, 1,2-dimethyl-3,4-difluoro-1,2,3,4-cyclobutane tetracarboxylic dianhydride, 1-methyl-3-fluoro-1,2,3,4-cyclobutane tetracarboxylic dianhydride, and 1-methyl-4-fluoro-1,2,3,4-cyclobutane tetracarboxylic dianhydride, while the aromatic tetracarboxylic dianhydride may include at least one selected from the group consisting of pyromellitic dianhydride, benzophenone tetracarboxylic dianhydride, oxydiphthalic dianhydride, biphthalic anhydride, and hexafluoroisopropylidene diphthalic dianhydride.

Further, the diamine monomer may be represented by Formula (III):

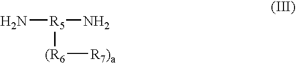

wherein R₅ is an aliphatic group or an aromatic group; R₆ is one selected from —O—, —COO—, —OCO—, —NHCO—, and —CONH—; R₇ is a group selected from a linear, branched, or cyclic alkyl group having 1 to 30 carbon atoms, an unsaturated hydrocarbon group having 7 to 40 carbon atoms, a saturated cyclic hydrocarbon group, and a mixture thereof; and a is an integer from 1 to 10.

The diamine monomer may include at least one of para-phenylenediamine, meta-phenylenediamine, 4,4-oxydianiline, 4,4-methylenedianiline, 2,2-bis(aminophenyl)hexafluoropropane, meta-bis(aminophenoxy)diphenylsulfone, para-bis(aminophenoxy)diphenylsulfone, 1,4-bis(aminophenoxy)benzene, 1,3-bis(aminophenoxy)benzene, 2,2-bis[(aminophenoxy)phenyl]propane, and 2,2-bis[(aminophenoxy)phenyl]hexafluoropropane.

Also, the solvent may be at least one of dimethyl acetamide, dimethyl formamide, N-methyl-2-pyrrolidone, dimethyl sulfoxide, N-methylcaprolactam, dimethylsulfone, hexamethyl sulfoxide, tetramethylurea, pyridine, acetone, ethyl acetate, meta-cresol, tetrahydrofuran, chloroform, γ-butyrolactone, ethyl cellosolve, butyl cellosolve, ethyl carbitol, butyl carbitol, ethyl carbitol acetate, ethylene glycol, 1-methoxy-2-propanol, 1-ethoxy-2-propanol, 1-butoxy-2-propanol, 1-phenoxy-2-propanol, propylene glycol acetate, propylene glycol diacetate, propylene glycol 1-monomethyl ether 2-acetate, propylene glycol 1-ethyl ether 2-acetate, dipropylene glycol, dipropylene glycol monomethyl ether, 2-(2-ethoxypropoxy)propanol, methyl lactate ester, ethyl lactate ester, n-propyl lactate ester, n-butyl lactate ester, and isoamyl lactate ester. Furthermore, the copolymerizing of the tetracarboxylic dianhydride monomer and diamine monomer may further comprised a crosslinking agent.

The crosslinking agent may be comprised in an amount of about 20 wt % or less based on the total amount of the copolymer.

### BRIEF DESCRIPTION OF THE DRAWINGS

FIG. 1 is a layout view of a thin film transistor array panel for the liquid crystal display according to an exemplary embodiment of the present invention;

FIG. 2 is a layout view of a common electrode panel for the liquid crystal display according to an exemplary embodiment of the present invention;

FIG. 3 is a layout view of the liquid crystal display including the thin film transistor array panel of FIG. 1 and the common electrode panel of FIG. 2;

FIG. 4 and FIG. 5 are cross-sectional views of the liquid crystal display of FIG. 3, illustrating the cross-sections cut along the IV-IV line and the V-V line, respectively;

FIG. 6 is a bar graph comparing the changes in the voltage holding rate (VHR) of the alignment layer listed in Table 2; and

FIG. 7 is a graph showing the changes in the voltage holding rate (VHR) with the amount of contained crosslinking agent.

### DETAILED DESCRIPTION OF THE EXEMPLARY EMBODIMENTS

An exemplary embodiment of the present invention will hereinafter be described in detail with reference to the accompanying drawings.

As those skilled in the art would realize, the described exemplary embodiments may be modified in various different ways, all without departing from the spirit or scope of the present invention.

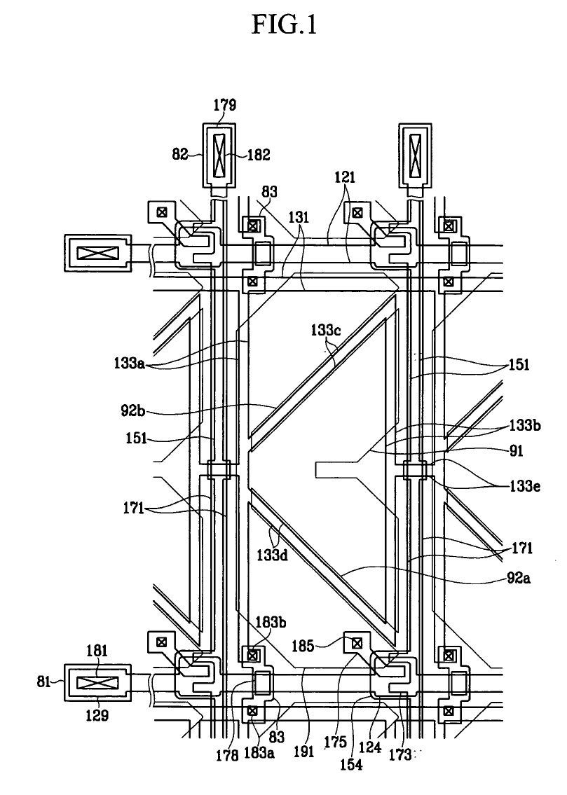

Now, a liquid crystal display according to an exemplary embodiment of the present invention will be described in detail with reference to FIG. 1 through FIG. 5.

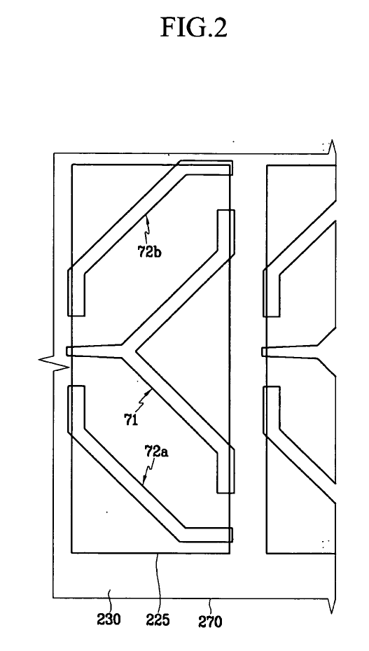

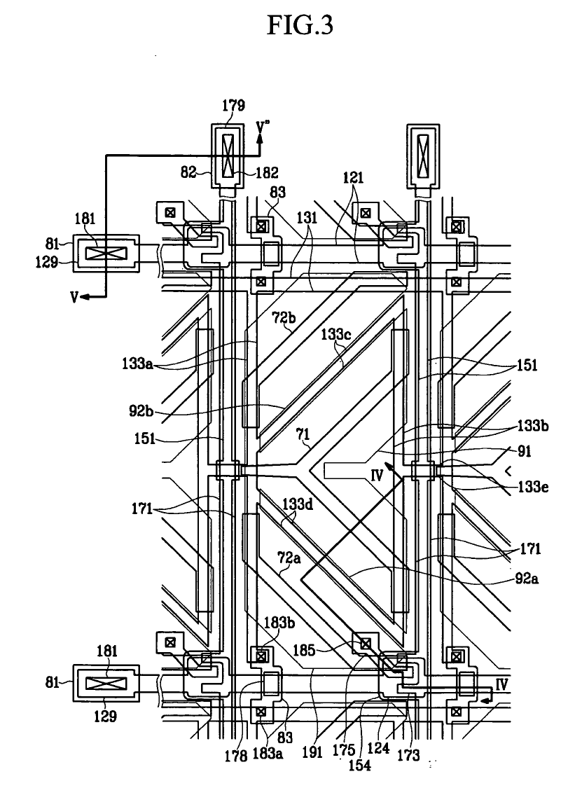

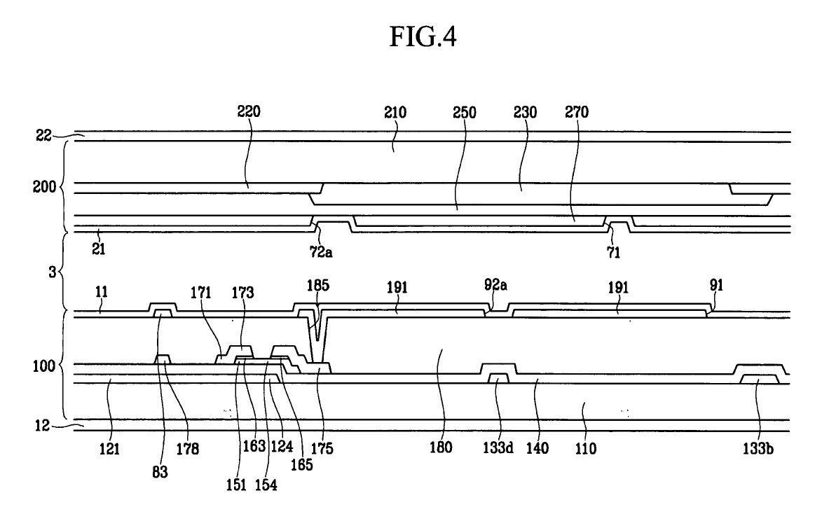

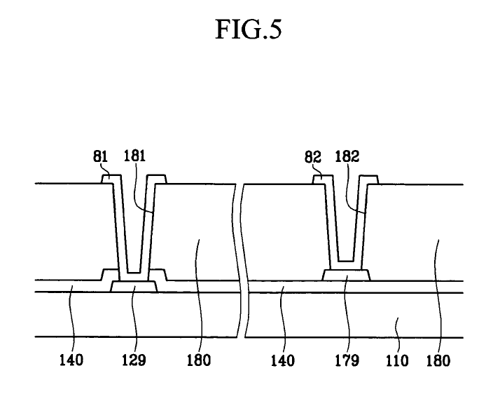

FIG. 1 is a layout view of a thin film transistor array panel for the liquid crystal display according to an exemplary embodiment of the present invention, FIG. 2 is a layout view of a common electrode panel for the liquid crystal display according to an exemplary embodiment of the present invention, and FIG. 3 is a layout view of a liquid crystal display including the thin film transistor array panel of FIG. 1 and the common electrode panel of FIG. 2. FIG. 4 and FIG. 5 are cross-sectional views of the liquid crystal display of FIG. 3, illustrating the cross-sections cut along the IV-IV line and the V-V line, respectively.

Referring to FIG. 1 to FIG. 5, the liquid crystal display according to an exemplary embodiment of the present invention comprises a thin film transistor array panel 100 and a common electrode panel 200 facing each other, and a liquid crystal layer 3 interposed between the panels 100 and 200.

First, the thin film transistor array panel 100 will be described with reference to FIG. 1, FIG. 3, FIG. 4, and FIG. 5.

A plurality of gate lines 121 and a plurality of storage electrode lines 131 are formed on an insulating substrate 110 made of, for example, transparent glass, plastic, or the like.

The gate lines 121 transmit gate signals, and mainly extend in a horizontal direction. Each gate line 121 includes a wide end portion 129 for connection between the plurality of gate electrodes 124 which protrude upward, and another layer or an external driving circuit. A gate electrode driving circuit that generates a gate signal may be mounted on a flexible printed circuit film attached onto the substrate 110, directly mounted on the substrate 110, or integrated with the substrate 110. When the gate driving circuit is integrated with the substrate 110, the gate electrode lines 121 may extend to be directly connected to the circuit.

Each of the storage electrode lines 131 receives a predetermined voltage. In addition, each of the storage electrode lines 131 includes a branch line that is substantially parallel to each of the gate lines 121, a group of a plurality of the first, the second, the third, and the fourth storage electrodes 133a, 133b, 133c, 133d that are diverged from the branch line, and a plurality of connections 133e. Moreover, each of the storage electrode lines 131 is positioned between two gate lines 121 that are adjacent to each other, and the branch line is close to an upper gate electrode line between the gate lines 121.

The first and second storage electrodes 133a and 133b extend in a vertical direction so as to face each other. The first storage electrode 133a has a fixed end portion that is connected to the branch line and a free end portion opposite to the fixed end portion. The fixed end portion has a projection. The third and fourth storage electrodes 133c and 133d obliquely extend from the center of the first storage electrode 133a to upper and lower portions of the second storage electrode 133b, respectively. The connections 133e are connected between the adjacent storage electrodes 133a to 133d. However, the shape and arrangement of the storage electrode lines 131 may be modified in various different ways.

The gate lines 121 and the storage electrode lines 131 may be made of, for example, an aluminum-based metal such as aluminum (Al) or an aluminum alloy, a silver-based metal such as silver (Ag) or a silver alloy, a copper-based metal such as copper (Cu) or a copper alloy, a molybdenum-based metal such as molybdenum (Mo) or a molybdenum alloy, chromium (Cr), tantalum (Ta), titanium (Ti), or the like. Further, the gate lines 121 and the storage electrode lines 131 may have a multilayer structure including two conductive layers whose physical properties are different from each other. One conductive layer is made of, for example, a metal having low resistivity, such as an aluminum-based metal, a silver-based metal, and a copper-based metal so as to suppress the signal delay or the voltage drop. On the contrary, the other conductive layer is made of a material having a good physical, chemical, and electrical contacting characteristics with ITO (indium tin oxide) and IZO (indium zinc oxide), for example a molybdenum-based metal, chromium, tantalum, and titanium. Examples of a preferable combination include a combination of a chromium lower layer and an aluminum (alloy) upper layer, and a combination of an aluminum (alloy) lower layer and a molybdenum (alloy) upper layer. However, the gate line 121 and storage electrode line 131 may be made of various metals or conductors.

Sides of the gate line 121 and the storage electrode line 131 are inclined relative to the surface of the substrate 110, and the inclination angle is preferably about 30° to about 80°.

On the gate line 121 and storage electrode line 131, a gate electrode insulating layer 140 that is made of, for example, silicon nitride (SiNx) or silicon oxide (SiOx) is formed.

On the gate insulating layer 140, a plurality of semiconductor stripes 151 that are made of, for example, hydrogenated amorphous silicon (abbreviated as hydrogenated a-Si) or polysilicon are formed. The semiconductor stripes 151 extend mainly in a longitudinal direction and have a plurality of projections 154 that protrude toward the gate electrode 124.

A plurality of ohmic contact stripes and islands 161 and 165 are formed on the semiconductor stripes 151. The ohmic contacts stripes and islands 161 and 165 may be made of, for example, a material such as n+ hydrogenated amorphous silicon that is heavily doped with an n-type impurity such as phosphorous or silicide. Each of the ohmic contact stripes 161 has a plurality of projections 163, and a pair of a projection 163 and an ohmic contact island 165 are disposed on the projection 154 of the semiconductor stripes 151.

The sides of the semiconductor stripes 151 and the ohmic contacts stripes and islands 161 and 165 are also inclined relative to the surface of the substrate 110, and the inclination angle is preferably about 30° to about 80°.

On the ohmic contacts stripes and islands 161 and 165 and gate insulating layer 140, a plurality of data lines 171, a plurality of drain electrodes 175, and a plurality of isolated metal pieces 178 are formed.

The data lines 171 transfer data signals, and extend mainly in a vertical direction to intersect the gate lines 121, the branch lines of the storage electrode lines 131, and the connections 133e. Each of the data lines 171 has a plurality of source electrodes 173 that extend toward the gate electrodes, and wide end portions 179 for connection with the other layers or external driving circuits. A data driving circuit that generates a data voltage may be mounted on a flexible printed circuit film that is attached onto the substrate 110, directly mounted on the substrate 110, or integrated with the substrate 110. When the data driving circuit is integrated with the substrate 110, the data lines 171 may extend to be directly connected to the circuit.

The drain electrodes 175 are formed to be separated from the data lines 171, and face the source electrodes 173 with the gate electrodes 124 interposed therebetween. Each of the drain electrodes 175 has a wide end and a rod-type end that is surrounded by the source electrode 173.

One gate electrode 124, one source electrode 173, and one drain electrode 175 form a single thin film transistor along with one projection 154 of the semiconductor stripes 151, and a channel of the thin film transistor is formed on the projectibn 154 between the source electrode 173 and the drain electrode 175.

The isolated metal pieces 178 are disposed on a portion of the gate electrode line 121 at the periphery of the first storage electrode 133a.

The data lines 171, the drain electrodes 175, and the isolated metal pieces 178 are preferably made of, for example, a refractory metal such as Mo, Cr, Ta, and Ti, or alloys thereof, and may have a multilayer structure including a refractory metal layer and a low-resistivity conductive film. Examples of the multilayer structure include a double layer having a chromium or molybdenum (alloy) lower layer and an aluminum (alloy) upper layer, or a triple layer having a molybdenum (alloy) lower layer, an aluminum (alloy) middle layer, and a molybdenum (alloy) upper layer. However, the data lines 171, the drain electrodes 175, and the isolated metal pieces 178 may be made of various metals or conductors.

Sides of the data lines 171, the drain electrodes 175, and the isolated metal pieces 178 are also inclined relative to a surface of the substrate 110, and the inclination angle is preferably about 30° to about 80°.

The ohmic contacts stripes and islands 161 and 165 are formed only between the semiconductor stripes 151 that are positioned under the ohmic contacts, the data lines 171, and the drain electrodes 175 that are positioned on the ohmic contacts, to reduce the contact resistance therebetween.

A passivation layer 180 is formed on the data lines 171, the drain electrodes 175, the isolated metal pieces 178, and an exposed portion of the semiconductor stripes 151. The passivation layer 180 is formed of, for example, an inorganic insulator or organic insulator, and has a flat surface. Examples of the inorganic insulator include silicon nitride (SiNx) and silicon oxide (SiOx). The organic insulator may have photosensitivity, and the dielectric constant thereof is preferably about 4.0 or below. The passivation layer 180, however, may, for example, have a double layer structure of an inorganic lower layer and an organic upper layer so as to have improved insulating characteristics of a dielectric layer, while also not damaging the exposed portion of the projection 154 of the semiconductor stripes 151.

A plurality of pixel electrodes 191, a plurality of overpasses 83, and a plurality of contact assistants 81 and 82 are formed on the passivation layer 180, and may be made of a transparent conductive material such as, for example, ITO or IZO or a reflective metal such as, for example, Al, Ag, or Cr.

The pixel electrode 191 is physically and electrically connected to the drain electrode 175 through the contact hole 185, and the data voltage is applied from the drain electrode 175 to the pixel electrode 191. The pixel electrode 191 that is applied with the data voltage forms an electric field along with the common electrode 270 of the common electrode panel 200 that is applied with the common voltage to determine the direction of liquid crystal molecules of the liquid crystal layer 3 interposed between the electrodes 191 and 270. The polarization of light passing through the liquid crystal layer 3 varies depending on the direction of the liquid crystal molecule as determined above. The pixel electrode 191 and the common electrode 270 form a capacitor (hereinafter, referred to as ‘liquid crystal capacitor’ to maintain the applied voltage even after the thin film transistor is turned off.

The pixel electrode 191 overlaps the storage electrode lines 131 including the storage electrodes 133a-133d. The pixel electrode 191 and the drain electrode 175 that is electrically connected to the pixel electrode 191 overlap the storage electrode lines 131 to form a capacitor, which is referred to as “a storage capacitor”. The storage capacitor improves the voltage-maintaining property of the liquid crystal capacitor.

Each of the pixel electrodes 191 has four main sides that are substantially parallel to the gate electrode lines 121 or the data lines 171, and four comers thereof are chamfered to be rectangular. The angle of the chamfered sides of the pixel electrode 191 is about 45° with respect to the gate lines 121. The pixel electrode 191 has a center cutout 91, a lower cutout 92a, and an upper cutout 92b, and is divided into a plurality of regions (partitions) by the cutouts 91 to 92b. The cutouts 91 to 92b are substantially inversion-symmetrical to an imaginary horizontal center line that divides the pixel electrode 191 into two portions.

The lower and upper cutouts 92a and 92b obliquely extend between the right and left sides of the pixel electrode 191 and overlap the third and fourth storage electrodes 133c and 133d. The lower and upper cutouts 92a and 92b are positioned in lower and upper portions of the horizontal center line of the pixel electrode 191, respectively. The lower and upper cutouts 92a and 92b are perpendicular to each other and are formed at 45° with respect to the gate line 121.

The center cutout 91 extends along the horizontal center line of the pixel electrode 191 and has an opening formed on the right side. The opening of the center cutout 91 has a pair of oblique sides that are substantially parallel to the lower cutout 92a and the upper cutout 92b. The center cutout 91 has horizontal portions and a pair of oblique lines connected to the horizontal portions. The horizontal portions extend shortly along the horizontal center line of the pixel electrode 191, and a pair of oblique lines extend from the horizontal portions to the right side of the pixel electrode 191 to be substantially parallel to the lower cutout 92a and the upper cutout 92b.

Accordingly, the lower portion of the pixel electrode 191 is divided into two regions by the lower cutout 92a, and the upper portion thereof is divided into two regions by the upper cutout 92b. In this case, the number of the regions or cutouts may vary depending on design components such as, for example, the size of the pixel electrode 191, the length ratio of the horizontal side and the longitudinal side of the pixel electrode 191, the type of liquid crystal layer 3, or other characteristics.

The overpass 83 intersects the gate line 121 and is connected to the exposed portion of the storage electrode line 131 and the exposed end of the free end of the first storage electrode 133 through the contact holes 183a and 183b that are opposite to each other with the gate lines 121 therebetween. The storage electrodes 133a and 133b, the storage electrode lines 131, and the overpass 83 are used for repairing defects of the gate lines 121, the data lines 171, or the thin film transistors.

The contact assistants 81 and 82 are connected to the end portions 129 of the gate lines 121 and the end portions 179 of the data lines 171 through the contact holes 181 and 182, respectively. The contact assistants 81 and 82 complement the attachment of the end portions 129 of the gate lines 121 and the end portions 179 of the data lines 171 to external devices, and protect them.

Next, with reference to FIG. 2 to FIG. 4, a common electrode panel 200 will be described.

A light blocking member 220 is formed on an insulating substrate 210 made of, for example, a transparent glass or plastic. The light blocking member 220 is referred to as a black matrix, and prevents light leakage between the pixel electrodes 191. The light blocking member 220 faces the pixel electrode 191 and has a plurality of openings 225 that have the substantially the same shape as the pixel electrode 191. The light blocking member 220, however, may have a portion corresponding to the gate line 121 and the data line 171, and a portion corresponding to the thin film transistor.

Further, a plurality of color filters 230 are formed on the substrate 210. Most of the color filters 230 are disposed in a region surrounded by the light blocking member 220, and may extend along the row of the pixel electrode 191 in a longitudinal direction. Each of the color filters 230 can display one of primary colors such as red, green, and blue.

An overcoat 250 is formed on the color filters 230 and the light blocking member 220. The overcoat 250 may be made of, for example, an (organic) insulating member, and prevents the color filters 230 from exposure to the outside and is formed as a flat surface. The overcoat 250 may be omitted.

A common electrode 270 is formed on the overcoat 250. The common electrode 270 is made of, for example, a transparent conductor such as ITO, IZO and has a plurality of cutouts 71, 72a, and 72b.

A group of cutouts 71 to 72b face one of pixel electrodes 191 and includes a center cutout 71, a lower cutout 72a, and an upper cutout 72b. Each of the cutouts 71 to 72b is disposed between adjacent cutouts 91 to 92b of the pixel electrode 191 or between cutouts 92a and 92b and chamfered sides. Further, each of the cutouts 71 to 72b has at least one of oblique sides that extends substantially parallel to the lower cutout 92a or the upper cutout 92b of the pixel electrode 191. The cutouts 71 to 72b are substantially inversion-symmetrical to the horizontal center line of the pixel electrode 191.

The lower and upper cutouts 72a and 72b have oblique lines, horizontal portions, and longitudinal portions. The oblique lines extend substantially from upper sides or lower sides of the pixel electrode 191 to left sides of the pixel electrodes 191. The horizontal portions and the longitudinal portions extend along the sides of the pixel electrode 191 from ends of the oblique lines to overlap the sides of the pixel electrode 191, and are formed at an obtuse angle with the oblique lines.

The center cutout 71 has center horizontal portions, a pair of oblique lines, and a pair of longitudinal portions. The center horizontal portions extend substantially along the horizontal center line of the pixel electrode 191 from the left side of the pixel electrode 191 to the right side thereof. The pair of oblique lines are formed at an obtuse angle with the center horizontal portions from ends of the center horizontal portions to the right side of the pixel electrode 191, and extend substantially parallel to the lower and upper cutouts 72a and 72b. The longitudinal portions extend along the right sides of the pixel electrode 191 from the ends of the oblique lines to overlap the right sides and be formed at an obtuse angle with the oblique lines.

The number of cutouts 71 to 72b varies depending on design components. The light blocking member 220 overlap the cutouts 71 to 72b to prevent the light leakage around the cutouts 71 to 72b.

When a common voltage is applied to the common electrode 270 and a data voltage is applied to the pixel electrode 191, an electric field that is substantially perpendicular to the surfaces of the display panels 100 and 200 is generated. In response to the electric field, the direction of the liquid crystal molecules is changed such that the longitudinal axis of the liquid crystal molecules is perpendicular to the direction of the electric field.

The cutouts 71 to 72b and 91 to 92b of the field generating electrodes 191 and 270 and the sides of the pixel electrode 191 generate a horizontal component that determines the oblique direction of the liquid crystal molecules by transforming the electric field. The horizontal component of the electric field is substantially perpendicular to the sides of the cutouts 71 to 72b and 91 to 92b and the sides of the pixel electrode 191.

Referring to FIG. 3, one group of cutouts 71 to 72b and 91 to 92b divides the pixel electrode 191 into a plurality of sub-areas, and each respective sub-area has two primary edges that are formed at an oblique angle with a primary edge of the pixel electrode 191. The primary edges of the sub-areas and a polarization axis of the polarizers 12 and 22 are formed at about 45°, which maximizes the optical efficiency.

As most of the liquid crystal molecules in the sub-areas are formed to be perpendicular to the primary edges, the oblique directions are four. Accordingly, due to the various directions of the liquid crystal molecules, the reference viewing angle of the liquid crystal display increases.

The shape and arrangement of the cutouts 71 to 72b and 91 to 92b may be modified in various different ways.

At least one of the cutouts 71 to 72b and 91 to 92b may be replaced with a projection or a depression. The protrusion may be made of, for example, an organic material or an inorganic material, and may be disposed on or under the field generating electrodes 191 and 270.

Alignment layers 11 and 21 are applied on inner surfaces of the display panels 100 and 200, and may be vertical alignment layers. The alignment layer 11 and 21 will be described in detail later.

Polarizers 12 and 22 are disposed on outer surfaces of the panels 100 and 200, and polarization axes of the polarizers 12 and 22 are perpendicular to each other and formed at about 45° with respect to the oblique cutouts 92a and 92b and the cutouts 71 to 72b. In the case of the reflective liquid crystal display, one of two polarizers 12 and 22 may be omitted.

The liquid crystal display according to the present exemplary embodiment may further include a retardation film for compensating the retardation of the liquid crystal layer 3. The liquid crystal display may further include a lighting unit (backlight unit) that emits light to the polarizers 12 and 22, the retardation film, the panels 100 and 200, and the liquid crystal layer 3.

The liquid crystal layer 3 has negative dielectric anisotropy, and is oriented such that the longitudinal axis of the liquid crystal molecules of the liquid crystal layer 3 is substantially perpendicular to the surfaces of the two display panels 100 and 200 when applying no electric field. Accordingly, the incident light does not pass through the crossed polarizers 12 and 22 and is blocked.

Now, alignment layers 11 and 21 according to an exemplary embodiment of the present invention will be described in detail. The alignment layers 11 and 21 are composed, for example, of a polymer containing polyamic acid having a plurality of amic acid groups and polyimide having a plurality of imide groups.

The polyamic acid and polyimide are represented, for example, by Formulas (I) and (II), respectively:

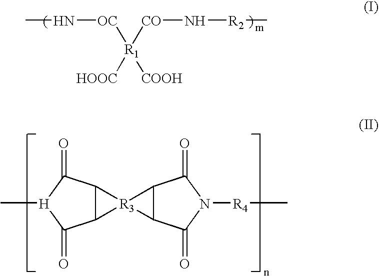

wherein R₁, R₂, R₃ and R₄, which may be same or different from each other, are each selected from an aliphatic group or an aromatic group.

In particular, the moieties 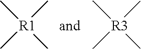
may be selected from the following:

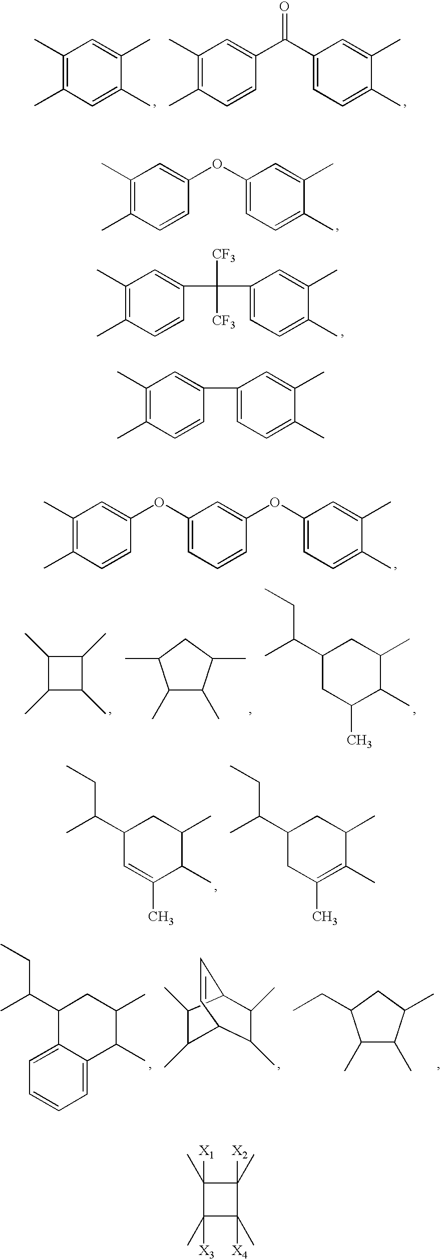

Further, the moieties —R2— and —R4— may be selected, for example, from the following:

The polymer can be obtained by copolymerizing a tetracarboxylic dianhydride and a diamine compound.

The tetracarboxylic dianhydride is selected from an aliphatic tetracarboxylic dianhydride and an aromatic tetracarboxylic dianhydride.

The aliphatic tetracarboxylic dianhydrides include, for example, 1,2,3,4-cyclobutane tetracarboxylic dianhydride, 1,2,3,4-cyclopentane tetracarboxylic dianhydride, 5-(2,5-dioxotetrahydrofuryl)-3-methylcyclohexane-1,2-dicarboxylic dianhydride, 5-(2,5-dioxotetrahydrofuryl)-3-methyl-3-cyclohexene-1,2-dicarboxylic, 5-(2,5-dioxotetrahydrofuryl)-3-methyl-4-cyclohexene-1,2-dicarboxylic dianhydride, 4-(2,5-dioxotetrahydrofuryl-3-yl)-tetraline-1,2-dicarboxylic dianhydride, bicyclooctene-2,3,5,6-tetracarboxylic dianhydride, 2,3,5-tricarboxyl cyclopentylcarboxylic dianhydride, 1,2,3,4-tetramethyl-1,2,3,4-cyclobutane tetracarboxylic dianhydride, 1,2-dimethyl-1,2,3,4-cyclobutane tetracarboxylic dianhydride, 1-methyl-1,2,3,4-cyclobutane tetracarboxylic dianhydride, 1,2,3,4-tetrafluoro-1,2,3,4-cyclobutane tetracarboxylic dianhydride, 1,2-difluoro-1,2,3,4-cyclobutane tetracarboxylic dianhydride, 1-fluoro-1,2,3,4-cyclobutane tetracarboxylic dianhydride, 1,2-dimethyl-3,4-difluoro-1,2,3,4-cyclobutane tetracarboxylic dianhydride, 1-methyl-3-fluoro-1,2,3,4-cyclobutane tetracarboxylic dianhydride, and 1-methyl-4-fluoro-1,2,3,4-cyclobutane tetracarboxylic dianhydride, and one or more species can be selected therefrom.

The aromatic tetracarboxylic dianhydrides include, for example, pyromellitic dianhydride, benzophenone tetracarboxylic dianhydride, oxydiphthalic dianhydride, biphthalic anhydride, and hexafluoroisopropylidene diphthalic dianhydride, and one or more species can be selected therefrom.

The diamine compound has a structure in which two amine groups (—NH₂) are attached to the aliphatic or aromatic cyclic structure, and one or more functional groups for vertically aligning the liquid crystal molecules are attached to the aliphatic or aromatic cyclic structure. The functional groups for vertically aligning the liquid crystal molecules interact with the terminal of the liquid crystal molecules, and allow the liquid crystal molecules to align in the vertical direction when no electric field is applied.

The diamine compound has a structure of Formula (III):

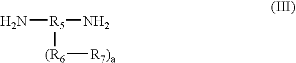

wherein R₅ is an aliphatic group or an aromatic group; R₆ is one selected from —O—, —COO—, —OCO—, —NHCO—, and —CONH—; R₇ is a group selected from a linear, branched, or cyclic alkyl group having 1 to 30 carbon atoms, a saturated hydrocarbon group having 7 to 40 carbon atoms, a saturated cyclic hydrocarbon group, and a mixture thereof; and a is an integer from 1 to 10.

In particular, the diamine compound may, for example, be selected from the group consisting of p-phenylenediamine, m-phenylenediamine, 4,4-oxydianiline, 4,4-methylenedianiline, 2,2-bis(aminophenyl)hexafluoropropane, m-bis(aminophenoxy)diphenylsulfone, p-bis(aminophenoxy)diphenylsulfone, 1,4-bis(aminophenoxy)benzene, 1,3-bis(aminophenoxy)benzene, 2,2-bis[(aminophenoxy)phenyl]propane, and 2,2-bis[(aminophenoxy)phenyl]hexafluoropropane.

The tetracarboxylic dianhydride and the diamine compound may be copolymerized at a ratio of 1:1, and the resulting polymer may have a weight average molecular weight (Mw) of about 10,000 to about 250,000 g/mol.

The polymer has a plurality of amic acid groups and a plurality of imide groups. The plurality of amic acid groups and the plurality of imide groups are irregularly arranged in the polymer, and the imidization ratio, which is about 85% or greater. Here, the imidization ratio is the proportion of the imide groups in the polymer, that is, the ratio of the number of imide groups to the total number of the amic acid groups and imide groups in the polymer.

The imidization ratio can be measured by Fourier transform infrared spectroscopy (FT-IR). That is, the relative amount of the imide groups in the polymer can be determined by using infrared spectroscopy, that is, by using the area of the peak for a benzene ring at around 1510 cm⁻¹ as the reference peak to calculate a change in the area of the peak for an imide group (C—N—C) at around 1380 cm⁻¹.

Thus, when the imidization ratio is about 85% or greater, a rapid decrease of the voltage holding ratio (VHR) that may occur when driving a liquid crystal display for a prolonged time, and display irregularities such as horizontal lines or longitudinal lines that may result therefrom, can be prevented.

The polymer as described above may be dissolve in a solvent to prepare solution for the alignment layer. The solvent may, for example, be at least one selected from the group consisting of dimethyl acetamide, dimethyl formamide, N-methyl-2-pyrrolidone, dimethyl sulfoxide, N-methylcaprolactam, dimethylsulfone, hexamethyl sulfoxide, tetramethylurea, pyridine, acetone, ethyl acetate, meta-cresol, tetrahydrofuran, chloroform, γ-butyrolactone, ethyl cellosolve, butyl cellosolve, ethyl carbitol, butyl carbitol, ethyl carbitol acetate, ethylene glycol, 1-methoxy-2-propanol, 1-ethoxy-2-propanol, 1-butoxy-2-propanol, 1-phenoxy-2-propanol, propylene glycol acetate, propylene glycol diacetate, propylene glycol 1-monomethyl ether 2-acetate, propylene glycol 1-ethyl ether 2-acetate, dipropylene glycol, dipropylene glycol monomethyl ether, 2-(2-ethoxypropoxy)propanol, methyl lactate ester, ethyl lactate ester, n-propyl lactate ester, n-butyl lactate ester, and isoamyl lactate ester.

Hereinafter, examples will be described in which polymers A, B, C, and D were prepared according to an exemplary embodiment of the present invention, and the voltage holding ratio and the display irregularities of the alignment layer formed from each of the prepared polymers were evaluated.

Polymers A, B, C, and D were prepared by polymerizing three types of tetracarboxylic dianhydride monomers (a, b, c) and three types of diamine monomers (d, e, f) shown below:

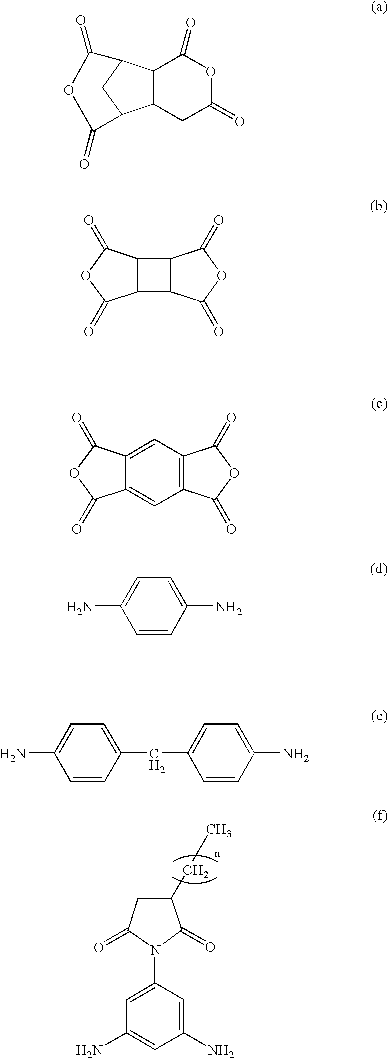

The tetracarboxylic dianhydride monomers (a, b, c) and the diamine monomers (d, e, f) were polymerized in equal portions (1:1), and the composition ratios of the respective monomers are as presented in Table 1 below.

TABLE 1

| | Tetracarboxylic dianhydride | | | Diamine compound | | | Crosslinking |
|---|---|---|---|---|---|---|---|
| | a | b | c | d | e | f | agent |
| | 1 | | | 1 | | | (%) |
| A | 0.70 | 0.15 | 0.15 | 0.3 | 0.3 | 0.4 | 20 |
| B | 0.53 | 0.23 | 0.24 | 0.3 | 0.3 | 0.4 | 10 |
| C | 0.50 | 0.25 | 0.25 | 0.3 | 0.3 | 0.4 | 10 |
| D | 0.50 | 0.25 | 0.25 | 0.4 | 0.2 | 0.4 | 10 |

The polymers obtained by polymerizing the monomers at the composition ratios as described above were respectively dissolved in dimethyl formamide (DMF), and an epoxy compound was added to each of the polymer solutions as a crosslinking agent.

Each of the solutions prepared as described above was applied on a substrate and then cured. Curing was performed at a temperature of about 180 to about 250° C. for about 10 to about 20 minutes. Subsequently, the cured alignment layers were peeled off by scratching, and were then subjected to the infrared spectroscopy as described above to determine the imidization ratios.

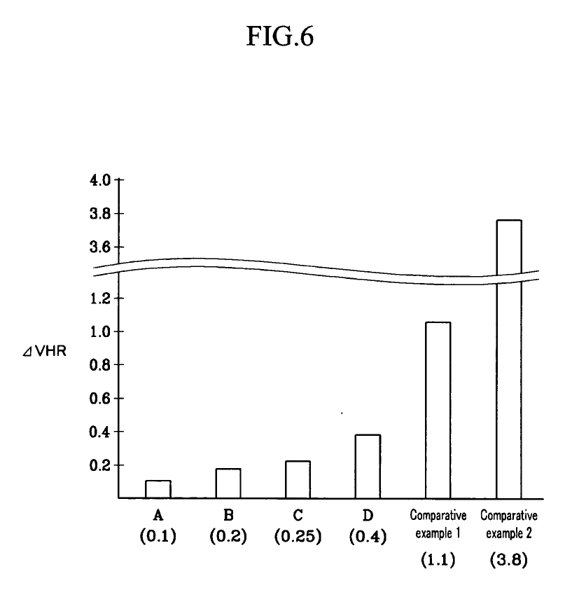

The voltage holding ratio and the presence or absence of display irregularities in accordance with the imidization ratio will be explained with reference to Table 2 and FIG. 6.

Table 2 shows the results of measuring the voltage holding ratio and the presence or absence of display irregularities in accordance with the imidization ratios of the alignment layers, while FIG. 6 is a bar graph comparing the changes in the voltage holding ratio of the alignment layers listed in Table 2.

In Table 2, reference numerals A, B, C, and D represent the alignment layers having the above-described polymers A, B, C, and D, and Comparative Examples 1 and 2 represent conventional alignment layers having imidization ratios of about 84% and about 60%, respectively.

TABLE 2

| | | | | | | | Time of Display |
|---|---|---|---|---|---|---|---|
| | | Amount of | | | | Display | Irregularities |
| | Imidization | Crosslinking | VHR | | | Irregularities | Occurrence |
| | ratio (%) | Agent (%) | Initial | 530 HR | ΔVHR | (10,000 HR) | (HR) |
| A | 90 | 20 | 99.20 | 99.10 | 0.10 | X | 60,000 |
| | | | | | | | (predicted value) |
| B | 90 | 10 | 99.10 | 98.90 | 0.20 | X | 30,000 |
| | | | | | | | (predicted [symbol] |
| C | 87 | 10 | 99.10 | 98.85 | 0.25 | X | 24,000 |
| | | | | | | | (predicted [symbol] |
| D | 85 | 10 | 99.00 | 98.60 | 0.40 | X | 16,000 |
| | | | | | | | (predicted [symbol] |
| Comp. | 84 | 10 | 98.60 | 97.50 | 1.10 | ◯ | 6000 |
| Ex. 1 | | | | | | | (measured [symbol] |
| Comp. | 60 | 20 | 97.40 | 93.60 | 3.80 | ⊚ | 1600 |
| Ex. 2 | | | | | | | (measured [symbol] |

Here, the voltage holding ratio was calculated from the voltage values measured initially and after about 530 hours under an applied voltage of about 1 V, and the display irregularities were measured by observing the display area for the presence of any irregularities appearing in the form of horizontal lines or longitudinal lines, after operating the display for about 10,000 hours.

As shown in Table 2 and FIG. 6, it can be seen that the amount of change in the voltage holding ratio (ΔVHR) decreases as the imidization ratio increases. It was also found that there was no appearance of display irregularities, which occur with a decrease in the voltage holding ratio, when the imidization ratio was about 85% or greater. Furthermore, judging from the measured values of the time of display irregularities occurrence for Comparative Example 1 and Comparative Example 2, it can be predicted that the exemplary embodiments A, B, C, and D will not exhibit any display irregularities until about 60,000 hours, about 30,000 hours, about 24,000 hours and about 16,000 hours, respectively, after the initiation of operation. Thus, it can be seen that a higher imidization ratio may result in a longer life span of the liquid crystal display.

In addition, it can be also seen from Table 2 that in the case of the alignment layers having the same imidization ratios, one containing a higher amount of crosslinking agent has a higher voltage holding ratio.

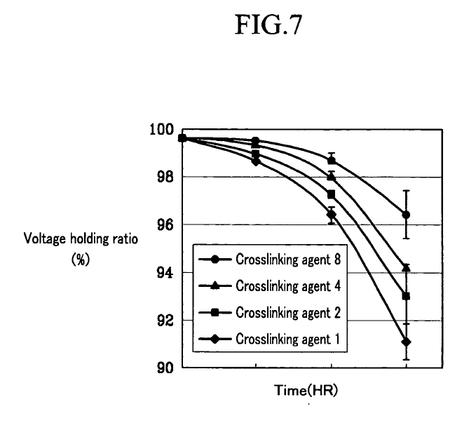

FIG. 7 is a graph showing the changes in the voltage holding ratio (VHR) with the amount of crosslinking agent in the alignment layers having the same imidization ratios.

As shown in FIG. 7, in the case of alignment layers having the same imidization ratios, one containing a higher amount of crosslinking agent has a higher voltage holding ratio because the crosslinking agent binds with the carboxyl group of the amic acid group and reduces the amount of the carboxyl group contained in the polymer.

The crosslinking agent may be exemplified by a compound having, for example, an epoxy group or a siloxane group, and any compound that is conventionally used as a crosslinking agent can be used, without limitation. The crosslinking agent is preferably contained in an amount of about 20 wt % or less based on the total amount of the copolymer.

As such, when the imidization ratio of the alignment layer is increased, a decrease in the voltage holding ratio and appearance of display irregularities can be prevented even upon operation of the liquid crystal display for a prolonged time, and thus the life span of the liquid crystal display can be increased while maintaining the traits of the liquid crystal display.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A liquid crystal display comprising:
a first panel and a second panel facing each other;
an alignment layer formed on at least one of the first panel and the second panel; and
a liquid crystal layer interposed between the first panel and the second panel and comprising liquid crystal molecules,
wherein the alignment layer comprises a polymer comprising a polyamic acid having a plurality of amic acid groups and a polyimide having a plurality of imide groups, and wherein the polymer has an imidization ratio of at least about 85%.

2. The liquid crystal display of claim 1, wherein the polyamic acid comprising the plurality of amic acid groups is represented by Formula (I): and 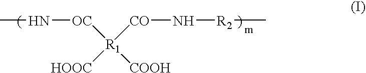
wherein the polyimide comprising the plurality of imide groups is represented by Formula (II): 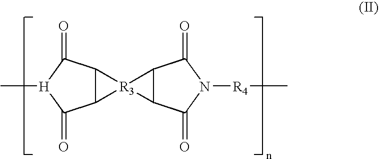
wherein R₁, R₂, R₃, and R₄ are each selected from an aliphatic group or an aromatic group, while R₁, R₂, R₃, and R₄ may be same or different from each other, and m and n are each an integer.

3. The liquid crystal display of claim 2, wherein the moieties 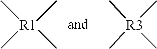
each comprise at least one of the following:

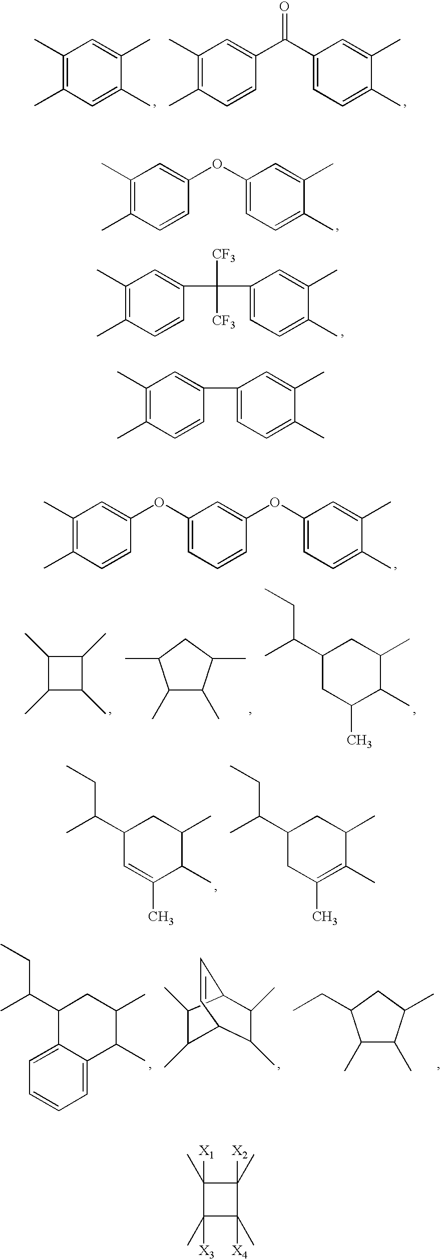

4. The liquid crystal display of claim 2, wherein the moieties —R2— and —R4— each comprise at least one of the following:

5. The liquid crystal display of claim 1, wherein the polymer is a copolymer of a tetracarboxylic dianhydride and a diamine compound.

6. The liquid crystal display of claim 5, wherein the tetracarboxylic dianhydride comprises at least one of an aliphatic tetracarboxylic dianhydride and an aromatic tetracarboxylic dianhydride;
wherein the aliphatic tetracarboxylic dianhydride includes at least one selected from 1,2,3,4-cyclobutane tetracarboxylic dianhydride, 1,2,3,4-cyclopentane tetracarboxylic dianhydride, 5-(2,5-dioxotetrahydrofuryl)-3-methylcyclohexane-1,2-dicarboxylic dianhydride, 5-(2,5-dioxotetrahydrofuryl)-3-methyl-3-cyclohexene-1,2-dicarboxylic dianhydride, 5-(2,5-dioxotetrahydrofuryl)-3-methyl-4-cyclohexene-1,2-dicarboxylic dianhydride, 4-(2,5-dioxotetrahydrofuryl-3-yl)-tetraline-1,2-dicarboxylic dianhydride, bicyclooctene-2,3,5,6-tetracarboxylic dianhydride, 2,3,5-tricarboxyl cyclopentylcarboxylic dianhydride, 1,2,3,4-tetramethyl-1,2,3,4-cyclobutane tetracarboxylic dianhydride, 1,2-dimethyl-1,2,3,4-cyclobutane tetracarboxylic dianhydride, 1-methyl-1,2,3,4-cyclobutane tetracarboxylic dianhydride, 1,2,3,4-tetrafluoro-1,2,3,4-cyclobutane tetracarboxylic dianhydride, 1,2-difluoro-1,2,3,4-cyclobutane tetracarboxylic dianhydride, 1-fluoro-1,2,3,4-cyclobutane tetracarboxylic dianhydride, 1,2-dimethyl-3,4-difluoro-1,2,3,4-cyclobutane tetracarboxylic dianhydride, 1-methyl-3-fluoro-1,2,3,4-cyclobutane tetracarboxylic dianhydride, and 1-methyl-4-fluoro-1,2,3,4-cyclobutane tetracarboxylic dianhydride; and
wherein the aromatic tetracarboxylic dianhydride comprises at least one of pyromellitic dianhydride, benzophenone tetracarboxylic dianhydride, oxydiphthalic dianhydride, biphthalic anhydride, and hexafluoroisopropylidene diphthalic dianhydride.

7. The liquid crystal display of claim 5, wherein the diamine compound is represented by Formula (III): 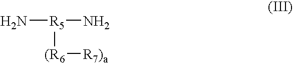
wherein R₅ is an aliphatic group or an aromatic group; R₆ is one selected from —O—, —COO—, —OCO—, —NHCO—, and —CONH—; R₇ is a group selected from a linear, branched, or cyclic alkyl group having 1 to 30 carbon atoms, an unsaturated hydrocarbon group having 7 to 40 carbon atoms, a saturated cyclic hydrocarbon group, and a mixture thereof; and a is an integer from 1 to 10.

8. The liquid crystal display of claim 5, wherein the diamine compound comprises at least one of p-phenylenediamine, m-phenylenediamine, 4,4-oxydianiline, 4,4-methylenedianiline, 2,2-bis(aminophenyl)hexafluoropropane, m-bis(aminophenoxy)diphenylsulfone, p-bis(aminophenoxy)diphenylsulfone, 1,4-bis(aminophenoxy)benzene, 1,3-bis(aminophenoxy)benzene, 2,2-bis[(aminophenoxy)phenyl]propane, and 2,2-bis[(aminophenoxy)phenyl]hexafluoropropane.

9. The liquid crystal display of claim 7 or claim 8, wherein the diamine compound contains a functional group for vertically aligning the liquid crystal molecules.

10. The liquid crystal display of claim 5, wherein the tetracarboxylic dianhydride monomer and the diamine monomer are copolymerized at a ratio of about 1:1.

11. The liquid crystal display of claim 1, wherein the polymer has a weight average molecular weight (Mw) of about 10,000 to about 250,000 g/mol.

12. The liquid crystal display of claim 1, wherein the first panel comprises:
a first substrate;
a gate line formed on the first substrate;
a data line crossing the gate line;
a thin film transistor connected to the gate line and the data line; and
a pixel electrode connected to the thin film transistor.

13. The liquid crystal display of claim 12, wherein the pixel electrode has cutouts.

14. The liquid crystal display of claim 1, wherein the liquid crystal molecules have negative dielectric anisotropy and are vertically aligned.

15. The liquid crystal display of claim 1, further comprising a tilt direction determining member that determines the direction of tilt of liquid crystal molecules in the liquid crystal layer.

16. The liquid crystal display of claim 15, wherein the tilt direction determining member comprises one of a cutout formed on at least one of the pixel electrode and the common electrode, or a protrusion formed on at least one of the pixel electrode and the common electrode.

17. A method for manufacturing a liquid crystal display, comprising:
forming a first signal line on a first substrate, a second signal line crossing the first signal line while being insulated, a thin film transistor connected to the first signal line and the second signal line, and a pixel electrode connected to the thin film transistor;
forming a common electrode on the second substrate to face the pixel electrode;
preparing a polymer comprising a polyamic acid having a plurality of amic acid groups and a polyimide having a plurality of imide groups;
applying the polymer on at least one of the pixel electrode and the common electrode; and
forming a copolymer having an imidization ratio of at least about 85% by curing the polymer.

18. The method for manufacturing a liquid crystal display of claim 17, wherein the curing of the polymer is carried out at temperature of about 180 to about 250° C.

19. The method for manufacturing a liquid crystal display of claim 18, wherein the curing of the polymer is carried out for about 10 to about 20 minutes.

20. The method for manufacturing a liquid crystal display of claim 17, wherein the preparing of the polymer comprises
copolymerizing a tetracarboxylic dianhydride monomer and a diamine monomer, and
dissolving the copolymerized compound in a solvent.

21. The method for manufacturing a liquid crystal display of claim 20, wherein the tetracarboxylic dianhydride monomer comprises at least one of an aliphatic tetracarboxylic dianhydride and an aromatic tetracarboxylic dianhydride;
the aliphatic tetracarboxylic dianhydride comprises at least one selected of 1,2,3,4-cyclobutane tetracarboxylic dianhydride, 1,2,3,4-cyclopentane tetracarboxylic dianhydride, 5-(2,5-dioxotetrahydrofuryl)-3-methylcyclohexane-1,2-dicarboxylic dianhydride, 5-(2,5-dioxotetrahydrofuryl)-3-methyl-3-cyclohexene-1,2-dicarboxylic dianhydride, 5-(2,5-dioxotetrahydrofuryl)-3-methyl-4-cyclohexene-1,2-dicarboxylic dianhydride, 4-(2,5-dioxotetrahydrofuryl-3-yl)-tetraline-1,2-dicarboxylic dianhydride, bicyclooctene-2,3,5,6-tetracarboxylic dianhydride, 2,3,5-tricarboxylcyclopentylcarboxylic dianhydride, 1,2,3,4-tetramethyl-1,2,3,4-cyclobutane tetracarboxylic dianhydride, 1,2-dimethyl-1,2,3,4-cyclobutane tetracarboxylic dianhydride, 1-methyl-1,2,3,4-cyclobutane tetracarboxylic dianhydride, 1,2,3,4-tetrafluoro-1,2,3,4-cyclobutane tetracarboxylic dianhydride, 1,2-difluoro-1,2,3,4-cyclobutane tetracarboxylic dianhydride, 1-fluoro-1,2,3,4-cyclobutane tetracarboxylic dianhydride, 1,2-dimethyl-3,4-difluoro-1,2,3,4-cyclobutane tetracarboxylic dianhydride, 1-methyl-3-fluoro-1,2,3,4-cyclobutane tetracarboxylic dianhydride, and 1-methyl-4-fluoro-1,2,3,4-cyclobutane tetracarboxylic dianhydride; and
the aromatic tetracarboxylic dianhydride comprises at least one of pyromellitic dianhydride, benzophenone tetracarboxylic dianhydride, oxydiphthalic dianhydride, biphthalic anhydride, and hexafluoroisopropylidene diphthalic dianhydride.

22. The method for manufacturing a liquid crystal display of claim 20, wherein the diamine monomer is represented by Formula (III): 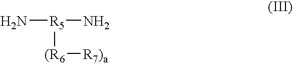
wherein R₅ is an aliphatic group or an aromatic group; R₆ is one selected from —O—, —COO—, —OCO—, —NHCO—, and —CONH—; R₇ is a group selected from a linear, branched, or cyclic alkyl group having 1 to 30 carbon atoms, an unsaturated hydrocarbon group having 7 to 40 carbon atoms, a saturated cyclic hydrocarbon group, and a mixture thereof; and a is an integer from 1 to 10.

23. The method for manufacturing a liquid crystal display of claim 20, wherein the diamine monomer comprises at least one of para-phenylenediamine, meta-phenylenediamine, 4,4-oxydianiline, 4,4-methylenedianiline, 2,2-bis(aminophenyl)hexafluoropropane, meta-bis(aminophenoxy)diphenylsulfone, para-bis(aminophenoxy)diphenylsulfone, 1,4-bis(aminophenoxy)benzene, 1,3-bis(aminophenoxy)benzene, 2,2-bis[(aminophenoxy)phenyl]propane, and 2,2-bis[(aminophenoxy)phenyl]hexafluoropropane.

24. The method for manufacturing a liquid crystal display of claim 20, wherein the copolymerizing comprises copolymerizing first, second, and third tetracarboxylic dianhydride monomers represented by Formulas (a), (b), and (c), respectively, with first, second and third diamine monomers represented by Formulas (d), (e), and (f), respectively:

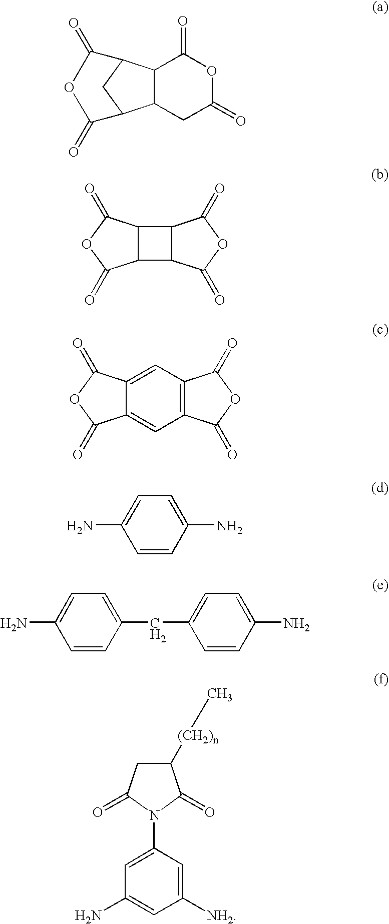

25. The method for manufacturing a liquid crystal display of claim 20, wherein the solvent comprises at least one of dimethyl acetamide, dimethyl formamide, N-methyl-2-pyrrolidone, dimethyl sulfoxide, N-methylcaprolactam, dimethylsulfone, hexamethyl sulfoxide, tetramethylurea, pyridine, acetone, ethyl acetate, meta-cresol, tetrahydrofuran, chloroform, γ-butyrolactone, ethyl cellosolve, butyl cellosolve, ethyl carbitol, butyl carbitol, ethyl carbitol acetate, ethylene glycol, 1-methoxy-2-propanol, 1-ethoxy-2-propanol, 1-butoxy-2-propanol, 1-phenoxy-2-propanol, propylene glycol acetate, propylene glycol diacetate, propylene glycol 1-monomethyl ether 2-acetate, propylene glycol 1-ethyl ether 2-acetate, dipropylene glycol, dipropylene glycol monomethyl ether, 2-(2-ethoxypropoxy)propanol, methyl lactate ester, ethyl lactate ester, n-propyl lactate ester, n-butyl lactate ester, and isoamyl lactate ester.

26. The method for manufacturing a liquid crystal display of claim 20, further comprising adding a crosslinking agent after the dissolving of the copolymerized compound in a solvent.

27. The method for manufacturing a liquid crystal display of claim 26, wherein the crosslinking agent is added in an amount of about 20 wt % or less based on the total amount of the copolymer.
